(19) United States
(12) Patent Application Publication
(10) Pub. No.: US 2004/0048733 A1
(43) Pub. Date: Mar. 11, 2004

(54) Method and system for providing certified reactivated carbon

(75) Inventors: Donald P. Traviss, Sewickley, PA (US); J. Michael Havelka, Sewickley, PA (US)

Correspondence Address: Richard L. Byrne, 700 Koppers Building, 436 Seventh Avenue, Pittsburgh, PA, 15219-1818, US

(73) Assignee: Envirotrol, Inc., Sewickley, PA

(21) Appl. No.: 10/438,310

(22) Filed: May 14, 2003

Related U.S. Application Data
(60) Provisional application No. 60/380,562, filed on May 14, 2002.

(51) Int. Cl. B01J 38/02

(52) U.S. Cl. 502/56

(57) ABSTRACT

Disclosed is a method and system for providing certified reactivated carbon. The method and system include the steps of: obtaining a certification for a portion of carbon particles from a first certifier by a supplier, thereby providing a certification for a portion of carbon particles; obtaining the certified portion of carbon particles from the supplier by a user facility; at least partially contaminating the certified portion of carbon particles by the user facility thereby providing a spent portion of carbon particles; obtaining at least a portion of the spent portion of carbon particles from the user facility by a treatment facility; reactivating the obtained spent portion of carbon particles by the treatment facility, thereby providing a reactivated portion of carbon particles; and obtaining a new certification for the reactivated portion of carbon particles from a second certifier, thereby providing a certified reactivated portion of carbon particles.

### CROSS REFERENCE TO RELATED APPLICATIONS

This application claims priority to U.S. Provisional Patent Application Serial No. 60/380,562, filed May 19, 2002.

### BACKGROUND OF THE INVENTION

1. Field of the Invention

The present invention relates generally to reactivation of carbon particles and, in particular, to a method and system for providing reactivated and certified carbon particles.

2. Description of Related Art

Activated carbon is in common use to remove impurities in compounds and from various substances. For example, activated carbon is used to treat water for utilization in high purity applications, such as beverage production. However, since most activated carbon is made from coal, contamination can occur in virgin carbon products due to the contaminants that naturally occur in the coal source. These contaminants include, for example, iron, sulfur, silica and other such materials.

In order to remove these contaminants, many carbon producers and carbon particle suppliers wash the virgin carbon with acid. However, the acid washing process is a costly one. Further, the acid washing process lowers the contact pH of the carbon to a point where it may prove to be problematic for certain consumers of the high purity carbon.

One example of a problem evolving from the use of acid washing is that when the high purity water passes through the acid wash to the carbon, the residual acid can elude from the carbon and contaminate the final product. Activated carbon producers and carbon particle suppliers typically ensure that a particular customer's carbon supply meets certain carbon purity specifications by obtaining certification through a regulatory or certifying body, such as the National Sanitation Foundation (NSF). The NSF is an industry standards organization and the testing protocols adopted by the organization were developed to ensure buyers that NSF-listed products meet a predefined purity and quality specification.

NSF-certified carbons also have certain limitations, for example, NSF-certified carbon particles from foreign or distant manufacturing sources may be contaminated during manufacturing or shipping. Such manufacturers or shippers may not have adequate safety or security measures to find and remedy these problems prior to shipment to domestic feedstocks. Thus, even some of the NSF-certified carbon may exhibit the contaminant drawbacks discussed above.

After the carbon feedstock is used in an application, it loses its effective properties and is called “spent” activated carbon. The spent activated carbon that has been used in municipal water treatment facilities is typically either landfilled or recycled back to the municipal facility. These carbons do not typically exhibit the contamination problems discussed above and may be suited for further use in other industries.

### SUMMARY OF THE INVENTION

It is an object of the present invention to provide a method and system for providing certified reactivated carbon that overcomes the deficiencies of the prior art. It is a further object of the present invention to provide a method and system for providing certified reactivated carbon for the beverage and food industries. It is another object of the present invention to provide a method and system for providing certified reactivated carbon at a decreased reactivation cost and an increased quality level.

The present invention includes a method for providing certified reactivated carbon, and includes the steps of: (a) obtaining a certification for a portion of carbon particles from a first certifier by a supplier, thereby providing a certified portion of carbon particles; (b) obtaining the certified portion of carbon particles from the supplier by a user facility; (c) at least partially contaminating the certified portion of carbon particles by the user facility, thereby providing a spent portion of carbon particles; (d) obtaining at least a portion of the spent portion of carbon particles from the user facility by a treatment facility; (e) reactivating the obtained spent portion of carbon particles by the treatment facility, thereby providing a reactivated portion of carbon particles; and (f) obtaining a new certification for the reactivated portion of carbon particles from a second certifier, thereby providing a certified reactivated portion of carbon particles. In a preferred embodiment, the user facility is a municipal water treatment facility, and the certified reactivated portion of carbon particles is provided to the beverage and food industry.

The present invention, both as to its construction and its method of operation, together with the additional objects and advantages thereof, will best be understood from the following description of exemplary embodiments when read in connection with the accompanying drawings.

### BRIEF DESCRIPTION OF THE DRAWINGS

FIG. 1 is a schematic diagram of a system for providing certified reactivated carbon according to the present invention; and

FIG. 2 is a flow chart of a method for providing certified reactivated carbon according to the present invention.

### DETAILED DESCRIPTION OF THE PREFERRED EMBODIMENTS

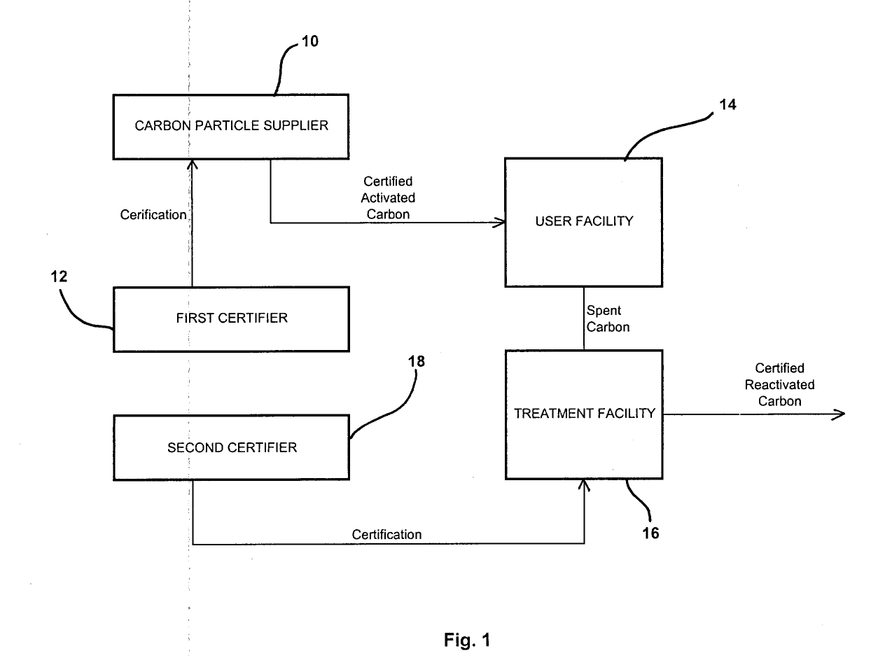

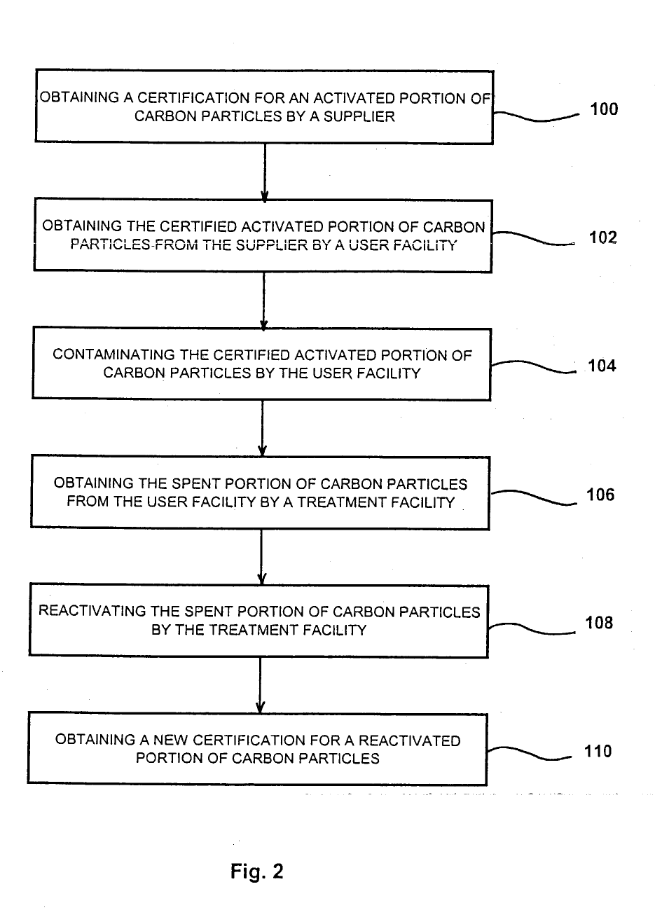

The present invention is a system (FIG. 1) and a method (FIG. 2) for providing certified reactivated carbon particles. As seen in FIG. 1, an activated carbon particle supplier 10 obtains a certification from a first certifier 12. This carbon particle supplier 10 may be either a broker or a manufacturer of activated carbon for use in various industries. Similarly, the first certifier 12 may be a regulatory agency, an industry standards organization or a similar industry, governmental or quasi-governmental body for promulgating standards, regulations or specifications relating to carbon particles. Once the carbon particle supplier 10 receives the certification from the first certifier 12, the carbon particle supplier 10 ships the certified activated carbon to a user facility 14.

The user facility 14 is typically a manufacturing or processing facility, which includes an internal process that uses the certified activated carbon to remove impurities from feedstocks and other material streams. For example, the certified activated carbon may be used to remove contaminants, both inorganic and organic, from various feed, process, intermediate and waste material streams in solid, semi-solid, slurry, gaseous and liquid forms. Once the user facility 14 has at least partially utilized the certified activated carbon, at least a portion of the carbon particles become contaminated, thereby producing a spent portion of carbon particles or spent carbon. At this point, the user facility 14 must purchase additional certified activated carbon from the carbon particle supplier 10 and, further, must dispose of the spent carbon, thusly creating a waste stream that requires disposal.

According to the present invention, a treatment facility 16 obtains at least a portion of this spent carbon from the user facility 14. This treatment facility 16 is particularly adapted to processing and/or otherwise reactivating this spent carbon and producing reactivated carbon for various industries. Once the treatment facility 16 has reactivated the carbon, a certification is obtained from a second certifier 18 for this reactivated carbon material. After the certification has been obtained, the treatment facility 16 is able to sell the certified reactivated carbon to certain other manufacturing and processing facilities for use in processing and contaminant removal.

The first certifier 12 and the second certifier 18 need not be separate and may be the same body or organization or an affiliated body or organization. In the preferred embodiment, the carbon particle supplier 10 obtains a certification from a specific and duplicative first certifier 12 and second certifier 18, such as the National Sanitation Foundation (NSF), and this certified activated carbon is sold by the carbon particle supplier 10. In this preferred embodiment, the user facility 14, which buys the certified activated carbon from the carbon particle supplier 10, is a municipal water plant. The municipal water plant uses this high-quality, virgin-activated carbon for taste and odor removal in the water treatment process. Typically, the municipalities will change the activated carbon when these taste and odor compounds (for example, geosmin, lignin, tannin, etc.) “break through” or adversely contaminate the carbon. Therefore, the spent carbon from these municipalities may be acquired for a minimal, and typically zero, cost and then processed thermally at the treatment facility 16. In this preferred embodiment, the treatment facility 16 uses thermal reactivation and is a NSF-certified food grade reactivation facility.

After the treatment facility 16 has discharged the carbon from a kiln, this reactivated carbon stream can be re-certified by the NSF for use in food grade applications. This reactivated carbon has typically been water-washed by the municipalities by 20 million to 100 million bed volumes of clean water. Water washing will remove inorganic impurities from the carbon over the period of time that the carbon is installed. The reactivation process at the treatment facility 16 will remove the trace amounts of taste and odor compounds. Further, the reactivation process will enhance the kinetic properties of the carbon by opening up additional transport pore structures to aid in the diffusivity of the organic compounds and chlorine deep into the adsorption pores. This process will create a technically superior activated carbon, as compared with the virgin carbon, by removing the inorganic contaminants, while meeting the needs of the pure water carbon consumers for a carbon that has a neutral contact pH. Therefore, the certified reactivated carbon from the treatment facility 16 is particularly useful in the food and beverage industry.

The present invention includes a method for providing certified reactivated carbon, which is illustrated in FIG. 2. The method includes the steps of: obtaining a certification for an activated portion of carbon particles by a carbon particle supplier 10 (step 100); obtaining the certified activated portion of carbon particles from the carbon particle supplier 10 by a user facility 14 (step 102); at least partially contaminating the certified activated portion of carbon particles by the user facility 14 (step 104); obtaining at least a portion of the spent portion of carbon particles from the user facility 14 by a treatment facility 16 (step 106); reactivating the obtained spent portion of carbon particles by the treatment facility 16 (step 108); and obtaining a new certification for the reactivated portion of carbon particles (step 110). Once the treatment facility 16 obtains this new certification from the second certifier 18, the treatment facility 16 sells the certified reactivated carbon to a new user facility 14.

In this manner, the present invention includes a method and system for providing certified reactivated carbon to a buyer facility. The certified reactivated carbon produced in this method and system will be both high in quality and, most importantly, free of inorganic contamination. This certified reactivated carbon will also ensure that beverage/food grade carbon consumers have a source or supply of high quality, contaminant free activated carbon. In addition, this certified reactivated carbon stream takes a traditional waste product and creates an economically viable feedstock material for the industry.

This invention has been described with reference to the preferred embodiments. Obvious modifications and alterations will occur to others upon reading and understanding the preceding detailed description. It is intended that the invention be construed as including all such modifications and alterations.

The invention claimed is:

1. A method of providing a certified reactivated portion of carbon particles, comprising the steps of:
(a) obtaining a certification for an activated portion of carbon particles from a first certifier by a supplier, thereby providing a certified activated portion of carbon particles;
(b) obtaining the certified activated portion of carbon particles from the supplier by a user facility;
(c) at least partially contaminating the certified activated portion of carbon particles by the user facility, thereby providing a spent portion of carbon particles;
(d) obtaining at least a portion of the spent portion of carbon particles from the user facility by a treatment facility;
(e) reactivating the obtained spent portion of carbon particles by the treatment facility, thereby providing a reactivated portion of carbon particles; and
(f) obtaining a new certification for the reactivated portion of carbon particles from a second certifier, thereby providing a certified reactivated portion of carbon particles.

2. The method of claim 1, wherein at least one of the first certifier and the second certifier is one of a regulatory agency, a governmental body, a quasi-governmental body and an industry standards organization.

3. The method of claim 2, wherein the at least one of the first certifier and the second certifier is the National Sanitation Foundation.

4. The method of claim 1, wherein the first certifier is identical to the second certifier.

5. The method of claim 1, wherein the user facility is a water treatment facility.

6. The method of claim 5, wherein the water treatment facility is a municipal water treatment facility.

7. The method of claim 1, wherein the treatment facility is a certified reactivation facility.

8. The method of claim 1, wherein the certification certifies at least one of the purity and the quality of the portion of carbon particles.

9. The method of claim 1, further comprising the step of obtaining the certified reactivated portion of carbon particles from the treatment facility by a second user facility.

10. The method of claim 9, wherein the second user facility is one of a food and beverage production facility.

11. The method of claim 1, further comprising the step of removing contaminants from a material by one of the certified activated portion of carbon particles and the certified reactivated portion of carbon particles.

12. The method of claim 11, wherein the contaminants are one of organic and inorganic contaminants.

13. The method of claim 11, wherein the material is at least one of a feed material, a process material, an intermediate material and a waste material.

14. The method of claim 11, wherein the material is in one of a solid, semi-solid, slurry, gaseous and liquid form.

15. The method of claim 1, further comprising the stem of:
at least partially contaminating the certified reactivated portion of the carbon particles by a second user; and
repeating steps (d)-(f).

16. The method of claim 1, wherein the treatment facility uses a thermal reactivation process to reactivate the obtained spent portion of carbon particles.

17. The method of claim 1, wherein the treatment facility is a National Sanitation Facility-certified food grade reactivation facility.

18. The method of claim 1, wherein, prior to step (d), the method further comprises the step of water washing the contaminated activated portion of carbon particles.

19. A method of providing a certified reactivated portion of carbon particles, comprising the steps of:
obtaining a certification for an activated portion of carbon particles from the National Sanitation Foundation by a supplier, thereby providing a certified activated portion of carbon particles;
obtaining the certified activated portion of carbon particles from the supplier by a water treatment facility;
at least partially contaminating the certified activated portion of carbon particles by the water treatment facility, thereby providing a spent portion of carbon particles;
obtaining at least a portion of the spent portion of carbon particles from the water treatment facility by a treatment facility;
reactivating the obtained spent portion of carbon particles by the treatment facility, thereby providing a reactivated portion of carbon particles;
obtaining a new certification for the reactivated portion of carbon particles from the National Sanitation Foundation, thereby providing a certified reactivated portion of carbon particles; and
obtaining the certified reactivated portion of carbon particles from the treatment facility by one of a food and beverage production facility.

20. A method of providing a certified reactivated portion of carbon particles, comprising the steps of:
obtaining a certification for an activated portion of carbon particles from a first certifier by a supplier, thereby providing a certified activated portion of carbon particles;
obtaining the certified activated portion of carbon particles from the supplier by a user facility;
at least partially contaminating the certified activated portion of carbon particles by the user facility, thereby providing a spent portion of carbon particles;
obtaining at least a portion of the spent portion of carbon particles from the user facility by a National Sanitation Facility-certified food grade reactivation facility;
reactivating the obtained spent portion of carbon particles by a National Sanitation Facility-certified food grade reactivation facility utilizing a thermal reactivation process, thereby providing a reactivated portion of carbon particles; and
obtaining a new certification for the reactivated portion of carbon particles from a second certifier, thereby providing a certified reactivated portion of carbon particles.
